(19) United States
(12) Patent Application Publication
(10) Pub. No.: US 2009/0198727 A1
(43) Pub. Date: Aug. 6, 2009

(54) TRACE-BASED DATABASE SCHEMA EVOLUTION METHOD AND SYSTEM

(75) Inventors: NING DUAN, Beijing (CN); Pei Sun, Beijing (CN); Jian Ming Zhang, Beijing (CN)

Correspondence Address: FLEIT, GIBBONS, GUTMAN, BONGINI & BIANCO P.L, 551 NW 77TH STREET, SUITE 111, BOCA RATON, FL, 33487, US

(73) Assignee: INTERNATIONAL BUSINESS MACHINES CORPORATION, ARMONK, NY (US)

(21) Appl. No.: 12/356,749

(22) Filed: Jan. 21, 2009

(30) Foreign Application Priority Data
Jan. 31, 2008 (CN) 200810004968.6

(51) Int. Cl. G06F 7/00; G06F 17/30

(52) U.S. Cl. 707/102; 707/E17.01; 707/E17.044

(57) ABSTRACT

A method, system, and computer program storage product perform an integrated trace-based database schema evolution. An original design model is imported. The original design model is edited. A set of alterations of the original design model resulting from editing the original design model is traced. The set of alterations is recorded. A schema evolution script and a data migration script are generated based on the set of alterations that have been recorded.

### CROSS REFERENCE TO RELATED APPLICATIONS

This application is based upon and claims priority from prior Chinese Patent Application No. 200810004968.6 filed on Jan. 31, 2008 the disclosure of which is hereby incorporated herein by reference in its entirety.

### FIELD OF THE INVENTION

The present invention generally relates to the field of database evolution, and more particularly to a trace-based database schema evolution method and system.

### BACKGROUND OF THE INVENTION

In the current field of commercial service applications, due to the logic of the commercial service and the database schema thereof are evolving due to the changeable demands of users. For instance, Software-as-a-Service (SaaS) system can be used to serve different terminal users by a type of system design. In a SaaS system, due to the increase of the number of users and the types of users, the demands of flexibility and individuation in scheme solutions become more and more important. For example, because of the functional design and/or non-functional design, there must be an alteration of the logic and database schema of the commercial service. Generally speaking, in the whole life cycle period of the commercial service, a continuous evolution is required in the commercial service system.

During the course of evolution of the commercial service system, the evolution of a database schema should be synchronous with the evolution of the commercial logic. In addition, since the data in the original commercial service system is still important for the commercial service system after evolution, the data migration must be accurate on the basis of the database schema alteration.

However, in the prior art, the commercial logic alteration and the database schema evolution are processed separately without the support of integration tools. Therefore, in the prior art, the evolution of the commercial service system is time-consuming, complicated, can easily have faults, and can have discrepancies between the model design of the commercial logic and the result of the database schema evolution.

For example, FIG. 1 illustrates the possible problems in the prior art. At present, a model-driven code generating technique is usually used to generate code for the commercial logic. In that case, the designer first designs a design model for the commercial service, and then the developer generates the code based on the design model and thus, build a commercial logic that is in accordance with the design.

As shown in FIG. 1, when demands change, a designer uses a design model alternating tool 101 to alter a design model, and then provide the new alternated design model to a developer and a database administrator (DBA), respectively. On one side, the developer imports the new model into a model driven tool 111. The model driven tool 111 parses the design model. Then, a code generator 112 generates code in accordance with the parsing result. The generated code is used by a commercial logic compiler 113 to build a corresponding commercial logic.

With respect to the right side of FIG. 1, in a completely different environment from the environment in which the commercial logic is built, the database administrator uses a database refactor tool 121 to operate on the new design model so as to generate a Refactor Point file. Then, by using the Refactor Point file, a schema evolution script generation tool 122 generates a schema evolution script, and a data migration script generation tool 123 generates data migration script. After that, a test database 124 is used to test the model evolution script and date migration script.

In the prior art, the database administrator usually needs to manually analyze the new design model to generate the Refactor Point file. Therefore, the generated script can easily become inconsistent with the generated code. Though this inconsistency can be eliminated by the database administrator and developer with extra communications through additional ways, this inconsistency increases the complexity and cost of the commercial service system evolution to a certain extent.

In addition, because the Refactor Point file is manually generated, the Refactor Point file is not guaranteed to correctly reflect the alteration of the design model. Therefore, in the debugging of the schema evolution script and data migration script, it might be necessary to alter the Refactor Point file. This increase, to some extent, the complexity, and cost of the database evolution.

A method for automated database schema evolution was disclosed in the U.S. patent application Ser. No. 10/670,947 (below called Reference 1) titled “Method for Automated Database Schema Evolution”, filed on Sep. 25, 2003 by Deepak S. Elandassery etc., which is hereby incorporated by reference in its entirety. In Reference 1, the model files of the new database and the original database are compared with each other in order determine the differences between them, and the database schema evolution is based on these differences. Reference 1 does not relate to data migration.

A method of database schema evolution is disclosed in the U.S. patent application Ser. No. 11/016,228 (below called Reference 2) titled “Differential Management of Database Schema Changes” and filed on Dec. 17, 2004 by Kang Ge etc., which is hereby incorporated by reference in its entirety. Similar to Reference 1, in Reference 2 the model files of the new database and the original database are compared with each other in order to find out the differences between them, and the database schema evolution is based on the differences.

The solutions of References 1 and 2 also have the same problems as discussed above. In addition, in References 1 and 2, the differences between the model files of the new database and the original database are determined by comparing them with each other. But this approach is unable to or is very difficult to trace the semantic information when database schema changes.

### SUMMARY OF THE INVENTION

In order to resolve the above mentioned problems, the various embodiments of the present invention provide a trace-based database schema evolution method and system.

In one embodiment, an integrated trace-based database schema evolution method is disclosed. The method comprises importing an original design model. Alterations of the original design model are traced and recorded when editing the original design model. A schema evolution script and a data migration script are generated based on the alterations of the original design model.

An extensible operation set can be used in tracing and recording the alterations of the original model. The extensible operation set is used to generate the model evolution script and the data migration script. For example, the extensible operation set may include an adding operation, a deleting operation, a name-altering operation, and a moving operation etc. An intermediate file is used in tracing and recording the alteration of the design model. The original model is parsed to generate the intermediate file. The schema evolution script and the data migration script are generated homologously on the basis of the intermediate file.

In another embodiment, an integrated trace-based database schema evolution system is disclosed. The system includes a model editor, which is used to edit the original model and simultaneously to trace and record the alterations of the original design model. A script generator is used to generate a schema evolution script and a data migration script based on the alterations of the original design model. An extensible operational set module is coupled with the schema editor and the script generator. The extensible operational set module is used to maintain an extensible operation set which comprises the operation types that can be applied onto a design model as well as the corresponding schema evolution scripts templates and data migration script templates. For example, the extensible operation set may contain adding operation, deleting operation, name-altering operation, and moving operation etc. The model editor includes an intermediate file which is used to trace and record the alterations of the design model. A model parser is coupled with the model editor that is used to parse the original design model so as to generate an intermediate file. The script generator generates the schema evolution script and the data migration script homologously on the basis of the intermediate file.

One advantage of the present invention is that a new design model, a schema evolution script, and a data migration script are generated in an integrated way so as to guarantee the consistency among them and to decrease the work load. Another advantage is that alterations of a design model are traced and recorded while the design model is being edited so as to guarantee the consistency in the alterations of the design model, the schema evolution script, and data migration script. The semantic information in the alterations of the design model can be completely recorded, which simplifies the operations during the database schema evolution and the data migration. An extensible operation set is used, wherein the extensible operation set can be pre-defined, or be altered when required by the database administrator, which provides flexibility. In addition, the usage of an extensible operation set can standardize the operations of the design model so as to decrease the possibility of errors in design. Besides, since an extensible operation set can be used repeatedly, the work load of a designer is reduced. An intermediate file records the alterations of the design model while the script templates are kept in the extensible operation set. Therefore, the alterations and the debugging of the scripts can be independent from the intermediate file, which increase the flexibility of the script generation.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention, in which:

FIG. 1 schematically shows a prior art system for the evolution of a commercial logic and a database schema;

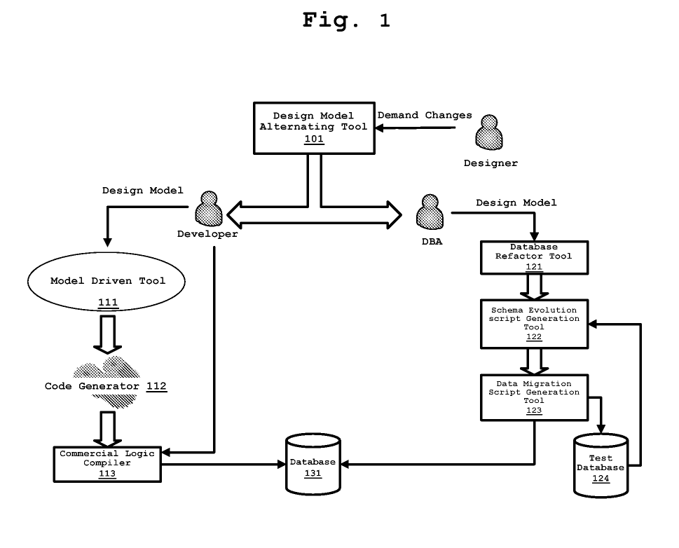

FIG. 2 is a block diagram schematically showing an integrated trace-based database schema evolution system according to one embodiment of the present invention;

FIG. 3 is a flowchart schematically showing an integrated trace-based database schema evolution method according to one embodiment of the present invention; and

FIG. 4 shows an example of the actual application of an integrated trace-based database schema evolution system according to one embodiment of the present invention.

### DETAILED DESCRIPTION

As For simplicity and clarification, in different drawings, like reference signs identify like elements. Besides, for the purpose to make description simple and not to blur the present invention in unnecessary aspects, detailed description of some well-known elements and steps are omitted.

It should be understood by a person skilled in the art that the previous description and the following detailed description are intended to be illustrative and not to limit the scope of the present invention.

The advantages of the various embodiments of present invention are illustrated through the examples below. It should be noted that a database schema evolution can include, but is not limited, the following:
deleting a column in the table of a database;
adding a column in the table of a database;
altering the name of a column in the table of a database; and
moving a column in the table of a database to other place, for instance, moving one column from one position to the other in a table, or moving a column from one table to another table.
   The database schema evolution further includes many others situations, and the above is merely illustrative.

In one embodiment, the database schema evolution comprises a schema evolution and a data migration, wherein the schema of a database refers to the table structures, index and column information etc of a database. Usually, a database administrator uses a schema evolution script and a data migration script to perform a database evolution. In the database evolution process, the database schema can be alternated by using the schema evolution script. For example, a database administrator can add, delete, alter, or move columns in the tables of a database by using a schema evolution script. Using a data migration script, the database administrator can move the data in the original database to the database resulting from the evolution. For instance, the data in the columns of the original database can be moved to the corresponding columns in the database resulting from the evolution.

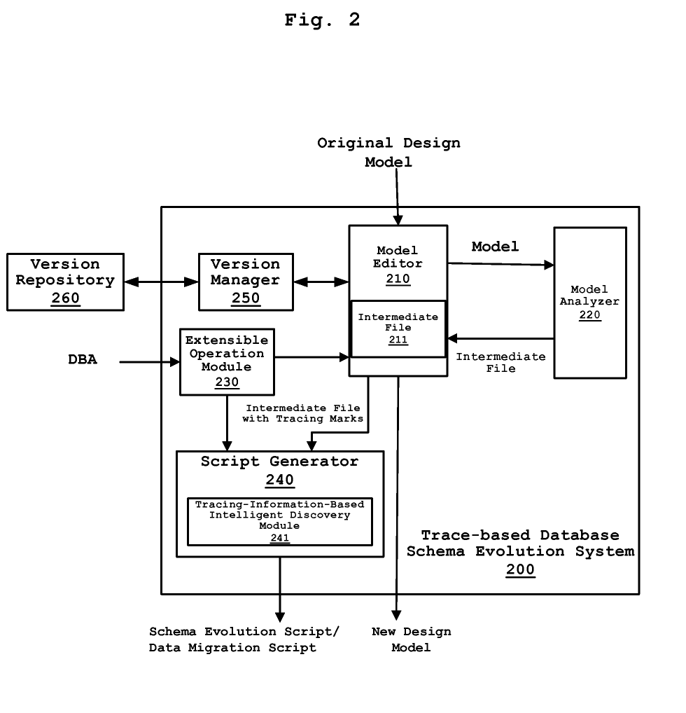

The integrated trace-based database schema evolution system of one embodiment of the present invention includes: a schema editor for editing an original design model and simultaneously tracing and recording the alterations of the original design model; and a script generator for generating a schema evolution script and a data migration script based on the alterations of the original design model. The structure of a trace-based database schema evolution system according to one embodiment of the present invention is discussed below with reference to FIG. 2.

For example, when a commercial demand changes, a designer can alter the original design model to generate a new design model by using the trace-based database schema evolution system 200 according to one embodiment the present invention. A design model is a model used to describe the data object relationship, which can, for example, be a class diagram, entity relationship (ER) mapping or object relationship (OR) mapping, etc. When demands change, a designer can alter the original design model to reflect and realize the alteration.

The trace-based database schema evolution system 200 according to one embodiment of the present invention provides to the designer an integrated environment for generating a design model, a schema evolution script, and a data migration script. As illustrated in FIG. 2, the system 200 according to one embodiment of the present invention includes a model editor 210, a model parser 220, an extensible operation module 230, and a script generator 240. An original design model is imported into the trace-based database schema evolution system 200. The designer can edit the imported original design model in the model editor 210. The integrated trace-based database schema evolution system 200 further includes an extensible operation set module 230 coupled with the schema editor 210 and the script generator 240. The extensible operation set module 230, in one embodiment, is used to maintain an extensible operation set that comprises the operation types that can be applied to a design model as well as the corresponding schema evolution script templates and data migration script templates.

In one embodiment, a user can pre-define the edit operations (edit types) applied onto a design model, wherein the edit types are pre-defined in the extensible operation set module 230. An example of editing a design model is discussed below, in which a designer adds a new field into the data object of the design model by using the design editor 210. First, the designer selects a design object of the design model and chooses a desired edit type (which is adding operation here). Then, the designer adds a new field into the data object. Alternatively, a user can enter default data for the field. For example, one type of editing can be the alteration of the entity name, the alteration of the attribute type, the alteration of the attribute name, the alteration of the attribute value, the alteration of the relationship, the deleting of the entity, the deleting of the attribute, the deleting of the relationship and the moving of the entity, etc. It should be noted that the edit types are not limited to the above examples. Also, in one embodiment, the extensible operation set includes at least one of an adding operation(s), a deleting operation (s), a name-altering operation(s), and a moving operation(s).

The model editor 210 further traces the alterations of the original design model. In one embodiment, the model editor 210 maintains an intermediate file 211. This intermediate file 211 is used to record the information of a design model and the tracing information of the alterations of the design model. Particularly, the intermediate file 211 may include, but is not limited to: entities constituting a design model; attributes constituting each entity; the type of each attribute; the relationship among entities, etc. For instance, the intermediate file is in a form of an XML file. However, it should be noted that the intermediate file is not limited to a form of an XML file. A non-limiting example of an intermediate file is given below:

```
<?xml version=“1.0” encoding=“UTF-8” ?>
- <xsd:schema xmlns:dsmodel=“http://EasyManLib”
    xmlns:xsd=“http://www.w3.org/2001/XMLSchema” targetNamespace=“http://EasyManLib”>
  <xsd:element name=“Model” type=“dsmodel:ModelType” />
- <xsd:complexType name=“ModelType”>
- <xsd:sequence>
  <xsd:element name=“entity” type=“dsmodel:EntityType” minOccurs=“0”/>
  <xsd:element name=“relationship” type=“dsmodel:RelationType” minOccurs=“0” />
  <xsd:element name=“version” type=“xsd:string” minOccurs=“0” />
  </xsd:sequence>
  <xsd:attribute name=“name” type=“xsd:string” />
  </xsd:complexType>
- <xsd:complexType name=“EntityType”>
- <xsd:sequence>
  <xsd:element name=“attribute” type=“dsmodel:AttributeType” minOccurs=“1” />
  <xsd:element name=“primaryKey” type=“xsd:string” minOccurs=“0” />
  <xsd:element name=“foreignkey” type=“xsd:string” minOccurs=“0” />
  <xsd:element name=“operation” type=“dsmodel:OperationType” minOccurs=“0” />
  </xsd:sequence>
  <xsd:attribute name=“Name” type=“xsd:string” />
  <xsd:attribute name=“DBName” type=“xsd:string” />
  </xsd:complexType>
- <xsd:complexType name=“RelationType”>
- <xsd:sequence>
  <xsd:element name=“src” type=“xsd:string” minOccurs=“1” />
  <xsd:element name=“des” type=“xsd:string” minOccurs=“1” />
  <xsd:element name=“operation” type=“dsmodel:OperationType” minOccurs=“0” />
  </xsd:sequence>
  <xsd:attribute name=“Name” type=“xsd:string” />
  </xsd:complexType>
- <xsd:complexType name=“AttributeType”>
- <xsd:sequence>
  <xsd:element name=“operation” type=“dsmodel:OperationType” minOccurs=“0” />
  </xsd:sequence>
  <xsd:attribute name=“Name” type=“xsd:string” />
  <xsd:attribute name=“Type” type=“xsd:string” />
  <xsd:attribute name=“defaultValue” type=“xsd:string” />
  </xsd:complexType>
- <xsd:complexType name=“OperationType”>
- <xsd:choice>
  <xsd:element name=“oldentityName” type=“xsd:string” minOccurs=“0” />
  <xsd:element name=“newentityvalue” type=“xsd:string” minOccurs=“0” />
  <xsd:element name=“oldattributevalue” type=“dsmodel:AttributeType” minOccurs=“0” />
  <xsd:element name=“newattributevalue” type=“dsmodel:AttributeType” minOccurs=“0” />
  <xsd:element name=“oldRelationship” type=“dsmodel:RelationType” minOccurs=“0” />
  <xsd:element name=“newRelationship” type=“dsmodel:RelationType” minOccurs=“0” />
  </xsd:choice>
  <xsd:attribute name=“Name” type=“xsd:string” />
  </xsd:complexType>
  </xsd:schema>
```

The model editor 210, in one embodiment, uses the intermediate file 211 to trace the alterations of the design model. For example, whenever the model editor 210 applies an editing operation onto the design model, the model editor 210 marks the operated data object, records the corresponding operation type, and parameters in the intermediate file. Consequently, it is possible to record simultaneously and accurately any alterations of the design model in the intermediate file 211. For example, according to one embodiment of the present invention, the designer can move a column from one table into another table and record this operation in the intermediate file 211.

When the editing of the design model is finished, the model editor 210 outputs an intermediate file with tracing marks and a new design model. In one embodiment, the trace-based database schema evolution system 200 further includes a model parser 220. The model parser 220 is used to parse a design model so as to generate an intermediate file for the model editor 210 to use. The script generator 240 receives the intermediate file with tracing marks from the model editor 210. Using the intermediate file with tracing marks, the script generator 240 can generate a homologous model evolution script and data migration script.

In one embodiment, the script generator 240 can further include a tracing-information-based intelligent discovery module 241. The tracing-information-based intelligent discovery module 241 can analyze the intermediate file with tracing marks and form a Refactor Point file. The Refactor Point file should be known to one of skill in the art. Based on the operation types marked in the Refactor Point file, the script generator 241 identifies the corresponding templates in the extensible operation set. The script generator 241 can then generate a schema evolution script and a data migration script.

The extensible operation set module 230 is associated with the model editor 210 and the script generator 240, and is used to maintain the extensible operation set, which includes a set of operations and corresponding database evolution script templates. The corresponding database evolution script templates comprise data-base schema evolution script templates and data migration script templates. The extensible operation set can be pre-defined in the trace-based database schema evolution system 200. In one embodiment, a database administrator can alter and extend the extensible operation set so as to satisfy the requirements of various schema evolutions.

Each operation in the extensible operation set may include the operation name, the operation type, the database schema evolution script template, and data migration template corresponding to the operation type, etc. As a non-limiting example, a few operations in the extensible operation set are illustrated below.

1. Operation for Moving a Column

```
OperationType= Move,
Object = Column,
Template ={
        --schema evolution script: create a column for an object
        ALTER TABLE $MoveTarget ADD COLUMN $ColumnName
        $Type;
        --data migration preparation script: built a temporary table
        CREATE TABLE $MoveSRC_BAK ($oldColumnsList);
        --data migration preparation script
        INSERT INTO $MoveSRC_BAK (SELECT * FROM
        $MoveSRC );
        Update $MoveTarget set $ColumnName = select
        $ColumnName from
$MoveSRC_BAK;
        --schema evolution script
        DROP TABLE $MoveSRC;
        CREATE TABLE $MoveSRC ($newColumnsList);
        --data migration preparation script
        INSERT INTO $MoveSRC (SELECT * FROM
        $MoveSRC_BAK );
        -- schema evolution script: delete the temporary table
        DROP TABLE $MoveSRC_BAK;
}
```

2. Operation for Altering the Name of a Column

```
OperationType= AlterName(AlterType),
Object = Column,
Template ={
        -- data migration preparation script: built a temporary table
        CREATE TABLE $Table_BAK ($oldColumnsList);
        -- data migration preparation script
        INSERT INTO $Table_BAK (SELECT * FROM $ Table);
        -- schema evolution script
        DROP TABLE $Table;
        CREATE TABLE $Table ($newColumnsList(contain new
        Name));
        -- data migration preparation script
        INSERT INTO $Table (SELECT $newColumnsList
        FROM $ Table _BAK
);
        -- schema evolution script: delete the temporary table
        DROP TABLE $Table_BAK;
}
```

3. Operation for Adding a New Column

```
OperationType= ADD Column,
Object = Column,
Template ={
        -- schema evolution script: create a column for an object
        ALTER TABLE $Table ADD COLUMN $ColumnName $Type;
        Update $ Table set $MoveTarget = $initialValue;
}
```

4. Operation for Deleting a Table

```
OperationType= Delete,
Object = Table ,
Template ={
        -- schema evolution script
        Drop Table $Target
}
```

It should be noted that the operations shown above merely illustrative and the operations in the extensible operation set are not limited to the operations shown above. The extensible operation set can be used by the model editor 210. For instance, when editing a design model by using the model editor 210, the model editor 210 records the alterations of the design model into the intermediate file 211 with reference to the operation names or operation types etc. The extensible operation set can also be used by the script generator 240. For instance, after the edition of the design model is completed, the script generator 240 uses the schema evolution script templates and/or the data migration script templates in the extensible operation set to generate a schema evolution script and/or a data migration script.

In one embodiment, the system 200 can further include a version managing module 250. The version managing module 250 can insert version information into a newly generated design model, schema evolution script, and data migration script. The version information can be used to keep the consistency among the schema evolution script, the data migration script, and the commercial logic code. With the version information, a designer and/or a developer can easily acquire the bench mark of the commercial logic code and the corresponding schema evolution script and data migration script.

In another embodiment, the version managing module 250 can be connected to a version repository 260, which is used to store the design models and the historical versions of the related schema evolution scripts and data migration scripts. A designer can use the version repository 260 to easily identify the corresponding commercial logic code, database schema evolution script, and data migration script through a version number. The trace-based database schema evolution method according to one the present invention comprises: importing a design model; tracing and recording the alterations of the original design model while editing the original design model; and generating a schema evolution script and a data migration script based on the alterations of the original design model.

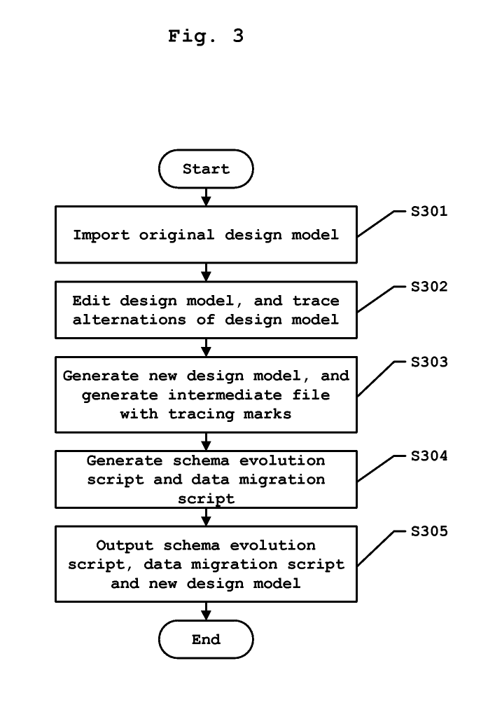

FIG. 3 shows a flowchart of the trace-based database schema evolution method 300 according to one embodiment of the present invention. When demands change, a designer makes alterations of the design model. According to one embodiment of the present invention, the designer can alter the design module in an integrated environment. In step S301, the designer imports the original design model into the trace-based database schema evolution system 200. In step S302, the designer uses the model editor 210 to edit the imported design model. In one embodiment, the model editor 210 can invoke the model parser 220 to parse the design model. The model parser 220 is imported with the design model, and determines whether or not the design model can be parsed. If the design model cannot be parsed, the model parser reports this and exits. Otherwise, the model parser 220 parses the design model and outputs an intermediate file for describing the design model for the model editor 210 to use.

In one embodiment, an extensible operation set can be used to trace and record the alterations of the original design model. The extensible operation set can be used to generate a schema evolution script and a data migration script. For instance, the designer can operate the design model through the extensible operation set. The operations that can be applied onto the design model can be defined in the extensible operation set. The extensible operation set may be pre-defined. In addition, according to the design, the database administrator can define an extensible operation set of his own.

When the design model is being edited, the alterations of the design model are traced and recorded. In one embodiment, the designer selects, from the extensible operation set, an operation type such as an operation for moving a column, an operation for adding a new column, an operation for altering the name of a columns or operation for deleting a table, etc. The design model can be operated by using these operation types, and the operation types are simultaneously recorded in the intermediate file 211. In one embodiment of the present invention, the consistency among the design model, the schema evolution script, and the data migration script is guaranteed because the editing and recording are simultaneous. In one embodiment, the extensible operation set comprises at least one of an adding operation, a deleting operation, a name-altering operation, and a moving operation. In one embodiment, the model editor 210 traces and records the alterations of the design model by using the intermediate file 211. In one embodiment, the model parser 220 parsers the original design model in order to generate the intermediate file.

In step S303, when the designer completes the editing of the design model, the model editor 210 outputs a new design model and an intermediate file with tracing marks. In step S304, based on the intermediate file with tracing marks, the script generator 240 can generate a database schema evolution script and a date migration script homologously. In one embodiment, an intelligent discovery program (module) can be used to parse the intermediate file with tracing marks, and find out the marked operation types therein. Then, according to the operation types, the corresponding schema evolution script templates and data migration script templates are retrieved in the extensible operation set. The corresponding schema evolution script and data migration script can be generated by using the retrieved templates.

In step S305, the new design model, schema evolution script, and data migration script are outputted. The developer can use the new design model to generate the commercial logical code and the corresponding commercial logic. Also, the database administrator can use the schema evolution script and data migration script to perform the evolution of the database. In one embodiment, version managing information can also be added into the new design model, the schema evolution script, and the data migration script. The design model, the schema evolution script, and the data migration script can be stored in a version repository. This embodiment is particularly advantageous when it is required to restore a previous version.

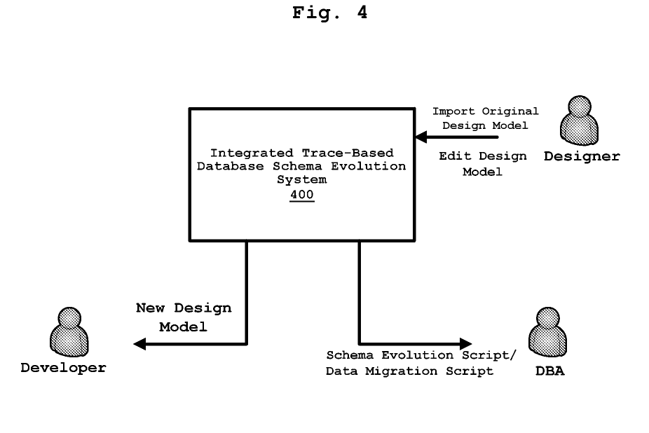

FIG. 4 illustrates one example in which an integrated trace-based database schema evolution system 400 is applied to an actual database schema evolution process. As shown in FIG. 4, when it is necessary for the database to be evolved due to demand changes, a designer imports an original design model into the integrated trace-based database schema evolution system 400. Then, the designer uses the system 400 to edit the design model. When the designer finishes the editing, the system 400 generates a new design model as well as a schema evolution script and/or a data migration script simultaneously. The new design model is provided to a developer. The developer can implement a new commercial logic by using a model-based code generating technique. The model evolution script and/or the data migration script are provided to a database administrator so as to perform an evolution of the database. The database administrator can also, on demands, alter the extensible operation set.

It is possible to carry out the method and system of the present invention in many ways. For example, it is possible to carry out the method and system of the present invention through software, hardware, firmware, and any combination thereof. The above discussed order of the steps for the method is only intended to be illustrative, and the steps of the method of the various embodiments of the present invention are not limited to the above specifically discussed order unless otherwise specifically stated. Also, in some embodiments, the various embodiment of the present invention can also be embodied as programs recorded and stored in a recording medium, including machine-readable instructions for implementing the method according to the various embodiments of the present invention.

In addition, based on above understanding, the object of the invention may also be achieved by one application or a group of applications running on any information processing equipment, which may be well-known universal equipment. Therefore, the object of the invention may also be achieved by simply providing a program product comprising program codes capable of realizing the method or apparatus as described above. That is to say, such a program product constitutes one or more embodiments of the present invention, and any storing media with such a program product stored therein also constitutes the one or more embodiments of the present invention. Obviously, said storing medium may be any well-known storing medium or any storing medium developed in the future, therefore it is unnecessary to list all the storing media here.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Although some specific embodiments of the present invention have been demonstrated above in detail with examples, it should be understood by a person skilled in the art that the above examples are only intended to be illustrative but not to limit the scope of the present invention. It should be understood by a person skilled in the art that the above embodiments can be modified without departing from the scope and spirit of the present invention. The scope of the present invention is defined by the attached claims.

What is claimed is:

1. A method for performing an integrated trace-based database schema evolution, the method comprising:
importing an original design model;
editing the original design model;
tracing a set of alterations of the original design model resulting from editing the original design model;
recording the set of alterations; and
generating a schema evolution script and a data migration script based on the set of alterations that have been recorded.

2. The method according to claim 1, wherein the tracing and the recording are performed using an extensible operation set, and wherein the schema evolution script is generated using the extensible operation set.

3. The method according to claim 2, wherein the extensible operation set comprises at least one of an adding operation, a deleting operation, a name-altering operation, and a moving operation.

4. The method according to claim 1, wherein the tracing and recording are performed using an intermediate file.

5. The method according to claim 4, further comprising:
parsing the original design model to generate the intermediate file.

6. The method according to claim 4, wherein the schema evolution script and the data migration script are generated homologously based on the intermediate file.

7. An integrated trace-based database schema evolution system, comprising:
a schema editor adapted to editing an original design model and simultaneously trace and record a set of alterations of the original design model; and
a script generator adapted to generate a schema evolution script and a data migration script based on the set of alterations of the original design model.

8. The system according to claim 7, further comprising:
an extensible operation set module coupled with the schema editor and the script generator, wherein the extensible operation set module is used to maintain an extensible operation set that comprises a set of operation types that can be applied onto a design model as well as a set of corresponding schema evolution script templates and a set of data migration script templates.

9. The system according to claim 8, wherein the extensible operation set comprises at least one of an adding operation, a deleting an operation, a name-altering operation, and a moving operation.

10. The system according to claim 7, wherein the model editor comprises an intermediate file that is used to trace and record the alterations of a design model.

11. The system according to claim 10, further comprising:
a model parser coupled with the model editor, which is used to parse the original design model so as to generate the intermediate file.

12. The system according to claim 10, wherein the script generator is adapted to generate the schema evolution script and the data migration script homologously based on the intermediate file.

13. A computer program storage product adapted to perform an integrated trace-based database schema evolution, the computer program storage product comprising instructions for:
importing an original design model;
editing the original design model;
tracing a set of alterations of the original design model resulting from editing the original design model;
recording the set of alterations; and
generating a schema evolution script and a data migration script based on the set of alterations that have been recorded.

14. The computer program storage product according to claim 13, wherein the tracing and the recording are performed using an extensible operation set, and wherein the schema evolution script is generated using the extensible operation set.

15. The computer program storage product according to claim 13, wherein the extensible operation set comprises at least one of an adding operation, a deleting operation, a name-altering operation, and a moving operation.

16. The computer program storage product according to claim 13, wherein the tracing and recording are performed using an intermediate file.

17. The computer program storage product according to claim 16, further comprising:
parsing the original design model to generate the intermediate file.

18. The computer program storage product according to claim 16, wherein the schema evolution script and the data migration script are generated homologously based on the intermediate file.
